(19) United States
(12) Patent Application Publication
(10) Pub. No.: US 2015/0066725 A1
(43) Pub. Date: Mar. 5, 2015

(54) Trend trading method

(71) Applicant: Huiqing Cai, El Monte, CA (US)

(72) Inventor: Huiqing Cai, El Monte, CA (US)

(21) Appl. No.: 13/987,760

(22) Filed: Aug. 28, 2013

(51) Int. Cl. G06Q 40/04

(52) U.S. Cl. CPC G06Q 40/04
USPC 705/37

(57) ABSTRACT

A system and method designed as a technical tool to accurately analyze the real time market trend dynamically in a simple effective way and also provide a simplified analysis that is easy to understand. A system and method that provides a user with more intuitive control of interface interactions and graphical interface visualization. The system and method of the present invention includes a trend stick chart, a power volume line, a 10 and 20 moving average line, and a price trend line. A trend trading method includes the steps of collecting price data of a tradable object in a given period in a market; generating the trend stick chart, the power volume line, the 10 and 20 moving average line, and the price trend line; combining and displaying the trend stick chart, the power volume line, the 10 and 20 moving average line, and the price trend line to form a resulted analysis for analyzing the tradable object in the market.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a stock trading analysis, and more particularly to a trend trading system and method, which is a simple and effective way to accurately analyze the market trend of securities, derivatives, currencies, and the likes.

2. Description of Related Arts

Many traders and analysts are constantly searching for ways to effectively predict the future price trend of securities, derivatives, or currencies over time in order to maximize the profit in the market. Therefore, many analyzing formulas and technical indicators have been designed and developed by mathematicians and engineers to calculate the price trend in the future. Some existing technical indicators, though still in use by traders and analysts, are outdated and cannot reflect the market trend to accurately predict the price trend. Since many individual traders are able to manage their own portfolios nowadays, these existing technical indicators are not able to adopt in the fast moving market anymore.

As shown in FIG. 1, a candlestick chart, which is well known in the prior art, is commonly used in technical analysis to describe price movements of securities, derivatives, or currencies over time. The Japanese have been using candlestick charts to analyze rice prices since the 17th century. As shown in FIG. 2, the candlestick consists of a body, an upper shadow (upper wick), and a lower shadow (lower wick). The body illustrates the opening and closing trade prices. When the closing trade price is higher than its opening trade price, the body of the high/bullish closing candlestick is filled with red color. As the opening trade price is higher than its closing trade price, the body of the low/bearish closing candlestick is filled with black color. Recently, due to the high printing cost, the hollow body (i.e. the body is unfilled) represents the high closing candlestick. In some Asian countries, when the body is filled with red color, it represents the high closing candlestick and if the body is filled with green color, it represents the low closing candlestick. While in some Western countries, when the body is filled with red color, it represents the low closing candlestick and if the body is filled with green color, it represents the high closing candlestick.

The upper and lower shadows illustrate the highest and lowest trade prices for a given period. In other words, the upper shadow of the high closing candlestick represents the difference between the highest trade price and the closing trade price. The lower shadow of the high closing candlestick represents the difference between the lowest trade price and the opening trade price. Likewise, the upper shadow of the low closing candlestick represents the difference between the highest trade price and the opening trade price. The lower shadow of the low closing candlestick represents the difference between the lowest trade price and the closing trade price.

The length of the candlestick varies with the price difference. When the price ranges between the opening trade price and the closing trade price increase, the body will be lengthened. Likewise, the upper or lower shadow will be longer due to the highest or lowest trade price, respectively.

The candlestick charts also conveys an Open-High-Low-Close Chart (OHLC Chart) in the United States. The OHLC chart not only uses vertical lines to show the price range during a given period but also illustrates the opening, the highest, the lowest, and the closing trade prices. In fact, the OHLC chart is a simplified display version of the candlestick chart.

Understanding the patterns of either the candlestick chart or the OHLC chart may give useful hints for the traders to make trading decisions. However, there are several drawbacks. Online trading is almost a norm these days, traders are able to manage their own portfolios instead of using professional brokers. However, without any financial strategy or supportive trading information, the online traders rely heavily on the candlestick chart to make their trading decisions in such fast-moving markets. On the other hand, the price data represented in the candlestick chart is the trade price data. Traders use this price data to determine how the market is moving. If the market becomes volatile, patterns of the candlestick chart will become unpredictable. Traders, especially those individual traders, will become restless with the high and low market volatilities. In addition, since traders have their common rational thinking, as the market is trending up, they are fearful of placing trade orders because of market volatility. After buying a stock during trending up market and as the stock price starts to drop from a high trade price, however, those traders are not willing to sell the stock because they are hoping the stock price may go up soon. As a result, they will make some profits on some trades but will loss in most trades. Therefore, as those loser-traders quit, the trade volume will be substantially reduced.

As it is mentioned above, since the price data shown in the candlestick chart represents traded price results and unable to determine the pricing trend, traders can easily make an inaccurate and unreasonable assumption on the trend in this unpredictable market.

### SUMMARY OF THE PRESENT INVENTION

The primary objective of the present invention is to provide a simple and effective-system and method to accurately analyze the market trend.

In accordance with an exemplary embodiment of the present invention, a trend trading system and method provides is a dynamically analyzing tool that updates and analyzes the current market trend in real time.

In accordance with an exemplary embodiment of the present invention, a trend trading system and method simplifies the analysis of the existing indicators in order to provide a simple and easy to understand analysis that enables traders to make more accurate predictions on the market trend.

In yet another exemplary embodiment of the present invention, a trend trading system and method generates an analysis result that indicates not only the market trend but also the market volume for the traders.

Additional objectives of features and advantages of the present invention will become apparent from the description which follows, and may be realized by means of the instrumentalities and combinations which particularly point out in the appended claims.

In further accordance with an exemplary embodiment of the present invention, the present invention, by foregoing of other features and objects from prior arts, additional features and advantages are achieved by providing a system and method, which comprises the following steps.

(1) Collects price data of a tradable object in a given period from the market, wherein the price data contains opening trade price, closing trade price, highest trade price, lowest trade price, trading volume, and current trade price.

(2) Generates a plurality of trend sticks in a trend stick chart that indicates a market trend in response to the price data.

(3) Generates a power volume line that indicates a decisive trading position of the tradable object to make a trade at the current trade price in the market.

(4) Provides 10 and 20 moving average that shows a direction of the market trend at the decisive trading position.

(5) Generates a price trend line that confirms the decisive trading position and the direction of the market trend.

(6) Combines and displays the trend stick chart, the power volume line, the 10 and 20 moving average, and the price trend line to show a resulted analysis that dynamically analyzes the tradable object in the market.

In further accordance with another embodiment of the present invention, the system and method comprises:

a communication center responsible for collecting price data of a tradable object in a given period of a market, wherein the price data contains opening trade price, closing trade price, highest trade price, lowest trade price, trading volume, and current trade price;

a processor, which processes the price data in order to generate a trend stick chart, a power volume line, 10 and 20 moving average, and a price trend line, wherein the trend stick line, having a plurality of trend sticks, indicates a market trend in response to the price data, wherein the power volume line indicates a decisive trading position of the tradable object to make a trade of the tradable object at the current trade price in the market, wherein the 10 and 20 moving average shows a direction of the market trend at a particular decisive trading position, wherein the price trend line confirms the particular decisive trading position and the direction of the market trend; and

an analyzing center which combines the trend stick chart, the power volume line, the 10 and 20 moving average, and the price trend line to form a dynamically analyzed result that analyzes the tradable object in the market and displays the trend stick chart, the power volume line, the 10 and 20 moving average, and the price trend line in a single screen manner.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 illustrates a conventional candlestick chart.

FIG. 2 illustrates components of a conventional candlestick.

FIG. 3 illustrates a trend stick chart according to a preferred embodiment of the present invention.

FIG. 4 illustrates components of a single trend stick according to the preferred embodiment of the present invention.

FIG. 5 illustrates an uptrend market shown in the trend stick chart according to the preferred embodiment of the present invention.

FIG. 6 illustrates a downtrend market shown in the trend stick chart according to the preferred embodiment of the present invention.

FIG. 7 illustrates the turning points shown in the trend stick chart according to the preferred embodiment of the present invention.

FIG. 8 illustrates the power volume line is incorporated-in the trend stick chart according to the preferred embodiment of the present invention.

FIG. 9 illustrates the power volume line incorporated with the 10 and 20 moving average line according to the preferred embodiment of the present invention, illustrating when the “market maker-likes” are likely desiring to enter into the market.

FIG. 10 illustrates the power volume line incorporating with the 10 and 20 moving average line according to the preferred embodiment of the present invention, illustrating the “market maker-likes” are likely desiring to leave the market.

FIG. 11 illustrates the price trend line according to the preferred embodiment of the present invention.

FIG. 12 illustrates an integrated platform that combines the trend stick chart, the power volume line, the 10 and 20 moving average, and the price trend line in a single integrated chart form, according to the preferred embodiment of the present invention.

FIG. 13 illustrates the operational interface of the trend trade system according to the preferred embodiment of the present invention.

FIG. 14 illustrates the displaying interface of the trend trade system according to the preferred embodiment of the present invention.

FIG. 15 is a block diagram illustrating the trend trading system according to the preferred embodiment of the present invention.

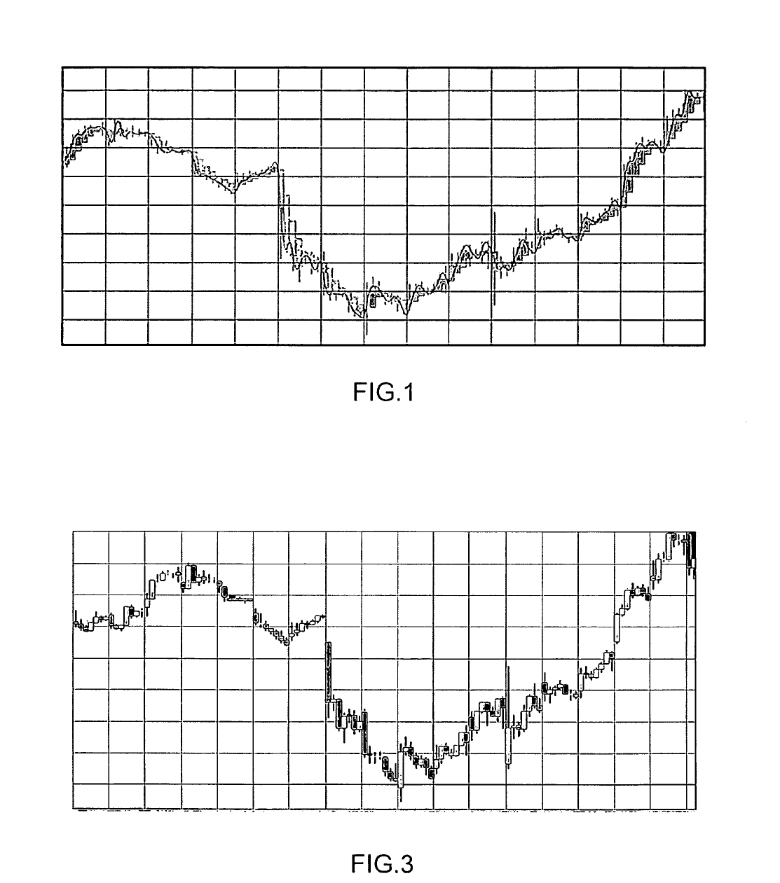

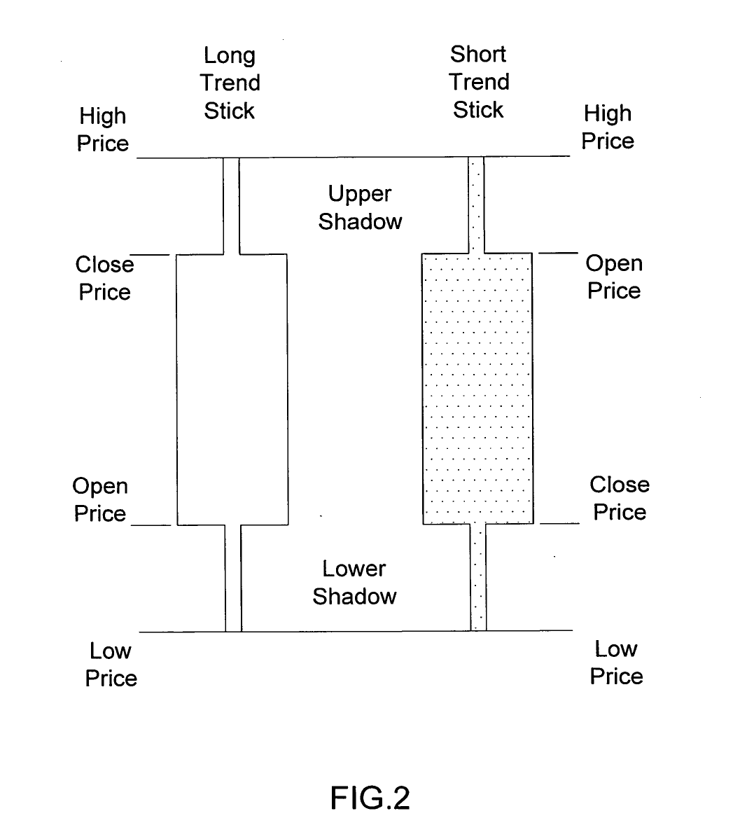

### DETAILED DESCRIPTION OF THE PREFERRED EMBODIMENT

The following description is disclosed to enable any person skilled in the art to make and use the present invention. The preferred embodiments, which are provided in the following description only serves as examples and modifications will be apparent to those skilled in the art. The general principles defined in the following description would be applied to other embodiments, alternatives, modifications, equivalents, and applications without departing from the spirit and scope of the present invention.

The present invention provides a trend trading system and method that simplifies and gives an effective way to accurately analyze the market trend. The system and method of the present invention provides at least four technical indicators to describe historical price data, momentum, and trend over time. In particular, the system and method, so called the trend trading system and method or, alternatively, Cai's Trading King System and Method, provide an accurately analyzing result based on the trade price data and price trend, wherein the analyzed result provides information of a decisive trading position to make a trade, whether buy or sell, in the fast-moving market.

The system and method (the trend trading system or Cai's Trading King System) of the present invention comprises the following components: a trend stick chart (so called Cai's Candlestick Chart), a power volume line (so called Cai's Gold Lin), 10 and 20 Moving Average, and price trend line (so called Emerald Line), provides technical tool that precisely analyzes the trend of the trade prices in the market dynamically. These components are the core to the system and method of the present invention.

In particular, the trend stick chart is arranged for displaying a market trend for a given period to indicate the uptrend market or the downtrend market, preferably by different colors, such as green for uptrend market and red for downtrend market. The power volume line indicates a decisive trading position to make a trade, i.e. buy or sell, at the current trade price in the market. The 10 and 20 moving average shows the market trend direction (short selling or short buying) at the decisive trading position. The price trend line confirms the decisive trading position and the market trend direction.

The price trend in the market is one of the major key factors when making and analyzing a trading decision, the trend stick chart, the 10 and 20 moving average line, and the price trend line are combined as a whole into one display to show the market trend; and furthermore, the power volume line is also incorporated to indicate the trading direction. Since the conventional analyzing tools analyze data statically (neither updates nor analyzes the market trend in real time) and use historical data to determine the support and resistance level and the market trend, the system and method of the present invention is a totally different analyze method and system. The system and method of the present invention analyzes data dynamically and does not constraint by time and human factors. The system and method of the present invention also offers traders the ability to decisively spot each trading position with a “market maker-like” ability.

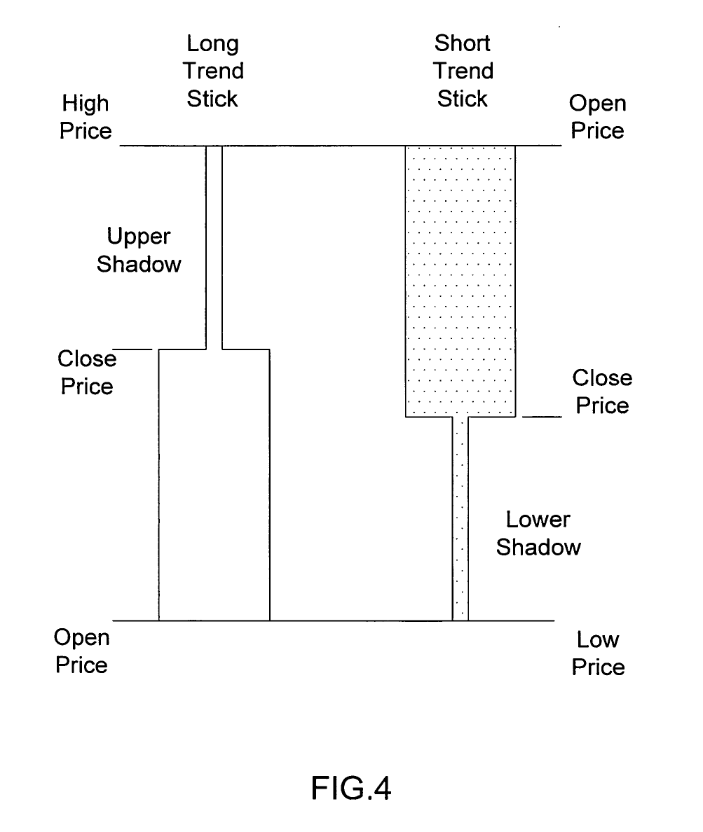

As shown in FIG. 3, the trend stick chart or Cai's Candlestick Chart, which is a modified version of candlestick chart, is developed based on the determination of the market trend and uses color to illustrate the trend of the market trend. The trend stick chart has a plurality of trend sticks each defining a body, an upper shadow, and a lower shadow, as shown in FIG. 4.

The trend stick chart combines two major factors, market price change and market trend, in order to form a market trend analysis that enables the traders to analyze the market trend directly. The trend stick chart also prevents the traders from making a misleading trade due to the disorderly and confusing color change of the conventional candlesticks. Therefore, the trend stick chart provides traders a tool to analyze the market trend rationally and technically.

The trend stick chart and its colors represent the price trend for a given period, such as daily, hourly, 30 minutes, or 15 minutes, or etc., wherein the price trend is formed by comparing the current trade price with the previous trade price including the lowest trade price (when trending up) and the highest trade price (when trending down). The following explains different conditions of the trend stick.

(a) When the current trade price is higher than the previous traded price, the trend stick will represent a bullish color, such as green, as shown in FIG. 5.

(b) When the current trade price starts to drop below the previous traded price, the lower shadow will start to extend downward from the body, as shown in FIG. 7 at point 3, to represent the trend of the market starting to change.

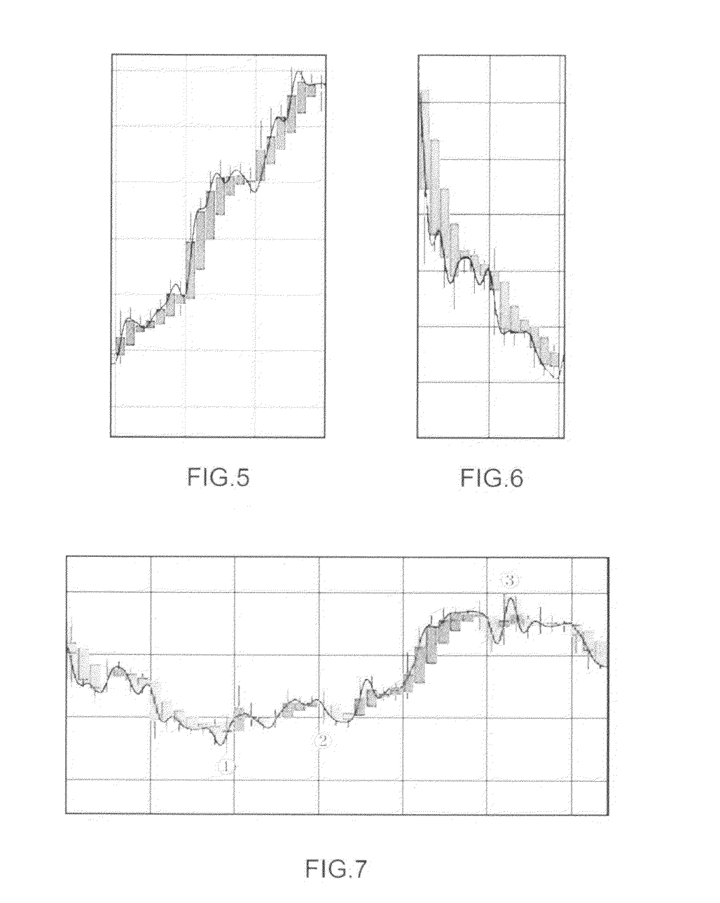

(c) When the current trade price is lower than the previous traded price, the trend stick will represent a bearish color, such as red, as shown in FIG. 6.

(d) When the current trade price starts to increase above the previous traded price, the upper shadow will start to extend upward from the body, as shown in FIG. 7 at point 1, to represent the trend of the market starting to change.

Accordingly, the trend stick chart precisely shows the change of the market trend by the bullish (green) color or the bearish (red) color. Furthermore, the bullish and the bearish colors of the trend sticks are shown in the chart to form an analysis for the traders instantaneously and dynamically in real time, as shown in FIG. 3.

In particular, when the market trends up, the trend stick will only have the upper shadow without the lower shadow, as shown in FIGS. 4 and 5. Likewise, as the market trends down, the trend stick will only have the lower shadow without the upper shadow, as shown in FIGS. 4 and 6. When the market trend is changing, that is from trending up to trending down or from trending down to trending up, the trend stick will have the upper and lower shadows with either the bullish or the bearish color, as shown in FIG. 7 at points 1, 2, and 3.

Since the trend stick chart of the present invention can effectively display the market trend, traders are able to make a rational analysis of the market trend technically. Therefore, the trend stick chart effectively resolves the conventional problems, including the uncertain, inaccurate, and unpredictable technical issues that surround the conventional candlestick chart.

In particular, the conventional candlestick chart only provides the price change in the market without accurately analyzing the market trend. In addition, the candlestick chart only indicates the market trend when one or more turning points are achieved. However, such technically analysis generated from these conventional indicators cannot apply to today's fast-moving market. In contrast, the trend stick chart of the present invention is more adapted to today's fast-moving market by providing a technical analysis that updates dynamically in real-time.

The power volume line or Cai's Gold Line, which is based on an average trade price and a standard price, is a technical analysis of a ratio of trading and the current trade prices.

Accordingly, a major factor of price volatility in various financial securities of securities market is the determination of buy and sell of the certain financial security product from the investors or traders, the selling volume will not be the same as the buying volume as a result. In other words, the selling and the buying prices will fluctuate correspondingly.

Investors or traders can be divided into two groups, market makers and individual traders. Market makers, who are largely made up of banks, funds, or institutions, have strong financial support and capitalization and ability to affect the market price and the market trend as their aspirations. Individual traders are made up of people who have relative less financial support or capitalization and can only follow the market trend from the market markers. Therefore, financial experts like to study the news and aspirations of those market makers. However, these studies are too complicated and too subjective for the individual traders to understand. In other words, the existing analysis does not show the trading purpose arranged by the market makers.

The power volume line of the present invention provides a way to show and analyze the trading movements of the market makers, including the following analyses.

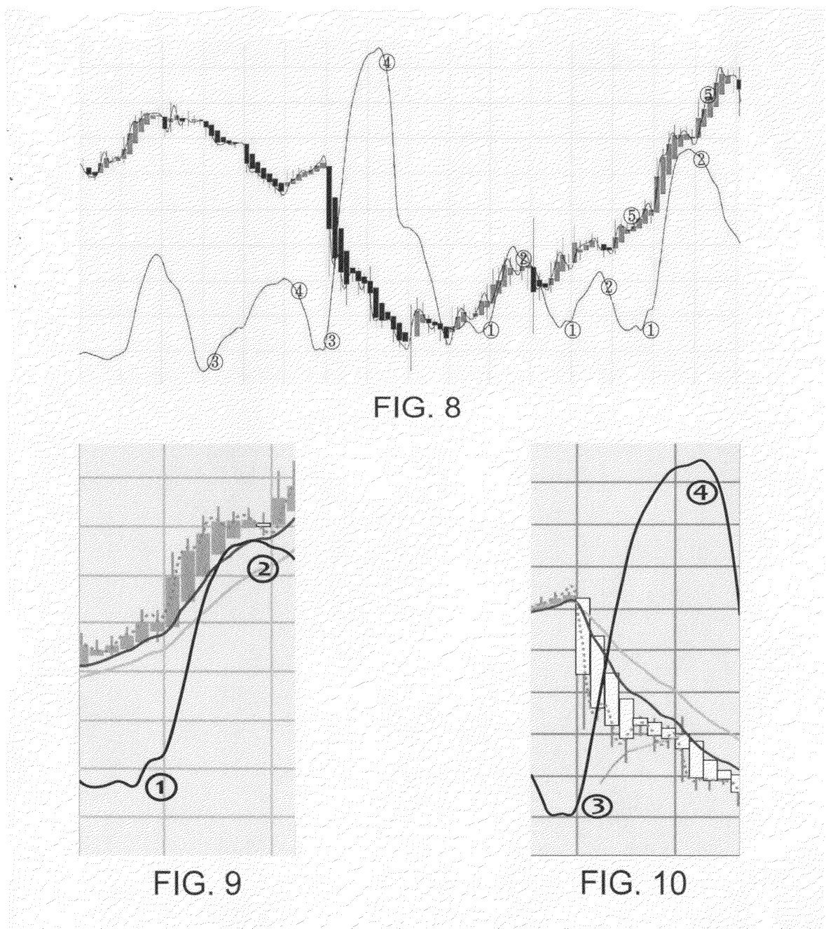

(1) When a buy volume in a single trade that is larger than a buy volume in multiple trades and when the current trade price starts to increase rapidly, it indicates the market-makers are desire to buy, as shown in FIG. 8 at point 1. In other words, numbers of buyers increase in the market and bull market will begin.

(2) When a sell volume in a single trade that is larger than a sell volume in multiple trades and when the current trade price starts to decrease rapidly, it indicates the market-makers are desire to sell, as shown in FIG. 8 at point 2. In other words, numbers of buyers reduce in the market and bear market will begin.

(3) When a short sell volume in a single trade that is larger than a short sell volume in multiple trades and when the current trade price starts to decrease rapidly, it indicates the market-makers are desire to “go short” or bear market begins, as shown in FIG. 8 at point 3. In other words, as the numbers of sellers increase in the market, bear market begins. Therefore, the trade price will plunge largely and rise insignificantly as the “go-short” market trends downward in long term.

(4) When a covering volume in a single trade is larger than a covering volume in multiple trades and when the current trade price starts to increase rapidly, it indicates the market makers are desire to leave the “go short” market or bear market, as shown in FIG. 8 at point 4. In other words, the “go-short” market or bear market will end.

(5) When the total volume in the market is about the same as the volume in multiple trades, and the current trade price is remained unchanged or slightly changed, it indicates both the market makers and the individual traders execute small amount of trading, as shown in FIG. 8 at point 5. Therefore, the market is relatively flat or rises/plunges slowly.

Therefore, by evaluating the trading volume of each financial security or tradable object and the frequencies of large and small trading volumes of each trade, the volume difference ratio (the difference between the current trading volume and the average trading volume) can be attributively calculated through computerized computation. This result will give an informative indication and accurately predicts any “market makers-like” activity in the market.

In particular, when the volume difference ratio is positive and is higher than a predetermined threshold, it indicates that the “market-makers-like” are likely desire to enter into the market. When the volume difference ratio is negative and is higher than a predetermined threshold, it indicates that the “market-makers-like” are likely desire to leave the market. When the volume difference ratio is either positive or negative and falls within a predetermined threshold range will indicate that the “market-makers-like” are likely neither desire to enter into nor desire to leave the market. In other words, almost all the traders are individual traders in the market. In another premise, by calculating the volume difference ratio with the current market price and the average price of previous period, the power volume line is created. The power volume line or Cai's Gold Line, is dynamically presented in real-time. Each of the turning points of the power volume line defines a critical trade region where for the “market-makers-like” will likely to enter or leave the market. The “market-makers-like” are defined as the trading activities in the market which are likely to be performed by the market-makers.

In particular, the power volume line will provide a dynamic and technical analyzing index line, represented in gold color, to technically analyze data dynamically by calculating a threshold value of volume difference ratio of market activities and market price ratio.

Since the power volume line provides the indication of the major activities, each critical trade region at a particular turning point represents either a buy point or a sell point. It combines with 10 and 20 moving average (an average price line) to visually and precisely point out whether the current trading price starts rising, at the peak, starts, or ends dropping.

When the power volume line starts to move upward at the turning point and the current trade price is above 10 and 20 moving average line will indicate that the “market-makers”likely desire to enter into the market, as shown in FIG. 9 at point 1. In other words, the market is trending up or starts to trend up.

When the power volume line starts to move downward at the turning point, it indicates that the activities of the “market-makers” are getting weaker and the “market-makers” likely desire to leave the market, as shown in FIG. 9 at point 2. In other words, the momentum of the uptrend market will be slowed down or will end.

When the power volume line starts to move upward at the turning point and the current trade price is below 10 and 20 moving average lines, it indicates that the “market-makers” likely desire to “go short” on the market, as shown in FIG. 9 at point 3. In other words, the market is trending down or starts to trend down.

When the power volume line starts to move downward at the turning point will indicate that the activities of the “market-makers” are getting weaker and the “market-makers” likely desire to leave the market, as shown in FIG. 9 at point 4. In other words, the momentum of the downtrend market will be slowed down or will end.

It is worth mentioning that there are different conventional indexes for analyzing the trade volume. While some conventional indexes are simple but with low accuracy, other indexes are too complicated to understand. By combining the power volume line (Cai's Gold Line) of the present invention with 10 and 20 moving average lines will not only provide individual traders more accurate trading information but also enable analysts and traders to analyze with ease.

The price trend chart, so called Emerald Line, is formed by price trend line, the Stochastic Oscillator (KD line), and the Moving Average Convergence/Divergence (MACD). The price trend line is an integrated analyzing chart that analyzes the price trend of the market.

The Stochastic Oscillator or KD line, which was presented by Dr. George Lane in the 1950s, is a momentum indicator that uses “support” and “resistance” levels or “Over Buy” or “Over Sell” that attempts to predict the price turning points by comparing the closing trade price with its price range for a given period.

The concepts of “Over Buy” or “Over Sell” and “predicting the price turning points” are very useful in price trend analysis. However, when the trade price does not fall within the “Over Buy” or “Over Sell” region, the price trend cannot be determined. In fact, the price trend will be unpredictable, as the Stochastic Oscillator cannot accurately predicate the price trend in this situation.

The MACD or Moving Average Convergence/Divergence, which was created by Gerald Appel, is a technical analysis indicator that is used to spot changes in strength, direction, momentum, and duration of the price trend. The MACD, which consists of MACD line, signal line, and divergence, is determined by the difference between a fast EMA (Exponential Moving Average) and slow EMA. However, the disadvantage of the MACD is that it does not contain any “Over Buy” or “Over Sell” region that allows traders to predict the price turning points.

The price trend line (the Emerald Line) of the present invention is determined by combining the Stochastic Oscillator with price changes in strength, direction, and momentum, and price trend cycle. In other words, the price trend line will not only show the “Over Buy” or “Over Sell” region but also precisely indicate the peak and the trough of the trend cycle.

When there is no significant turning point comparing with the closing trade price, the price trend line will be determined by the trend direction based on MACD. As soon as it enters into the “Over Buy” or “Over Sell” region, the prediction of the price turning point will be determined based on the Stochastic Oscillator. After the price turning point, the price trend will revert back based on MACD. This cycle continues. As a result, this will produce a precise indication of the peak and trough of the trend cycle. Thus it provides traders an easily operated trading decision.

When the difference between the current trade price and the closing trade price forms a price turning point, either the “Cross Over” or “Death Fork” will be shown in the price trend line. As the price trend remains stable or if the difference between the current trade price and the closing trade price is unchanged, the fast line and the slow line are slowly diverging that the “Cross Over” or “Death Fork” will not be shown in the price trend line. When the price trend enters the “Over Buy” and “Over Sell” regions and because the difference is confined by this area, the fast line and the slow line will slowly cross or intersect until a price turning point is formed. In addition, a non-traditional “Cross Over” or “Death Fork” will also be formed due to a sudden change of price during a stable price trend. Therefore, the price trend line will show the change of the price trend or the turning point of the price trend.

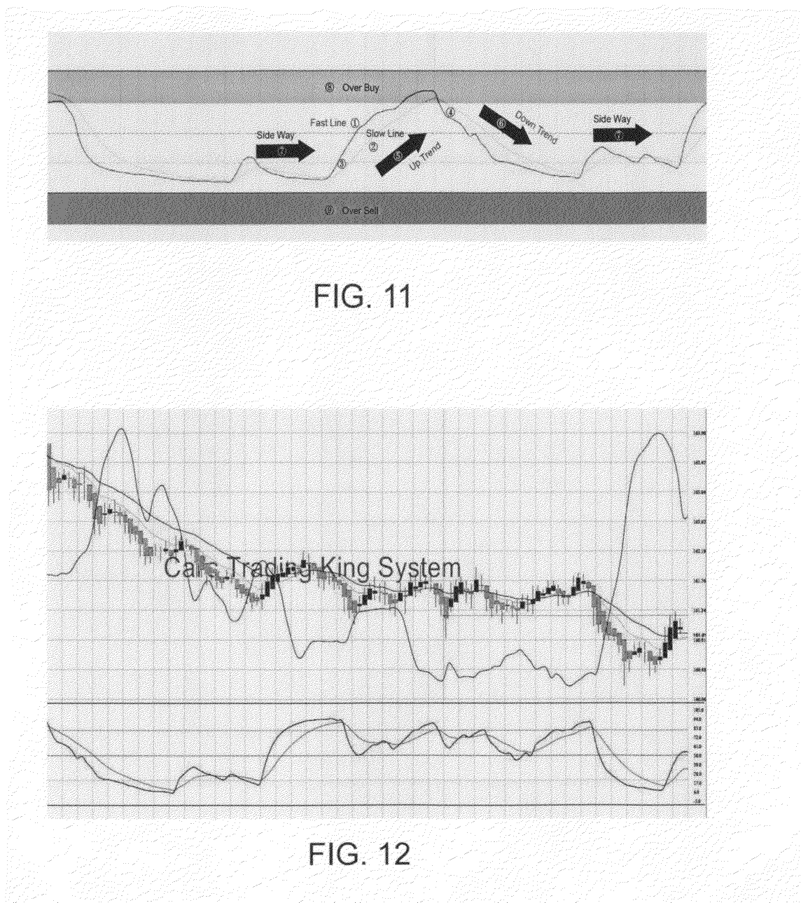

In particular, the price trend line (the Emerald Lin), which is determined from price ratio, consists of two lines, a fast line and a slow line, as shown in FIG. 11. The fast line, with a thicker line, as shown in FIG. 11 at point 1, is determined based on KD line. The slow line, with a thinner line, as shown in FIG. 11 at point 2, is determined based on MACD. When the fast line is above the slow line and intersects with the slow line, the “Cross Over” is formed, as shown in FIG. 11 at point 3. When the fast line is below the slow line and intersects with the slow line, the “Death Fork” is formed, as shown in FIG. 11 at point 4. The “Cross Over” indicates the trade price at an uptrend manner, as shown in FIG. 11 at point 5. The “Death Fork” indicates the trade price at a downtrend manner, as shown in FIG. 11 at point 6. When the “Cross Overs” and “Death Forks” are repeatedly formed, it indicates that the trade price is at a “side way” manner, as shown in FIG. 11 at point 7, that the trade price will fluctuate within a limited range, generally referring to upper and lower 5% fluctuation with the range.

The traders will be able to determine the current price trend, the change of the price trend, and the turning point of the price trend through the interaction between the fast line and the slow line. Since the price trend line has characteristic of the “Over Buy or “Over Sell” region, it is effectively incorporates with the power volume line to help determine whether the current trade price starts to change at a turning point. Even though “market-makers” may leave the market, there may be still have “individual traders like” activities in the market and the current trade price increases. In this situation, the price trend line will gradually go up at the “Over Buy” region, as shown in FIG. 11 at point 8, until a turning point is formed. Likewise, if the current trade price drops, the price trend line will gradually go down to the “Over Sell” region, as shown in FIG. 11 at point 9, unit a turning point is formed.

The major difference among the KD line, MACD, and the price trend line is that the characteristic of the KD line will cause the fast line to fluctuate due to the trade price volatility. In other words, the KD line does not precisely predicate the price trend in the market. In addition, MACD does not contain any “Over Buy” or “Over Sell” region at the top and bottom portions of the chart, traders always find it difficult to determine the turning point of the price trend in MACD. The price trend line (the Emerald Line) of the present invention resolves these problems by combining the advantages of both the KD line and MACD to precisely determine the price trend and its turning point in the market.

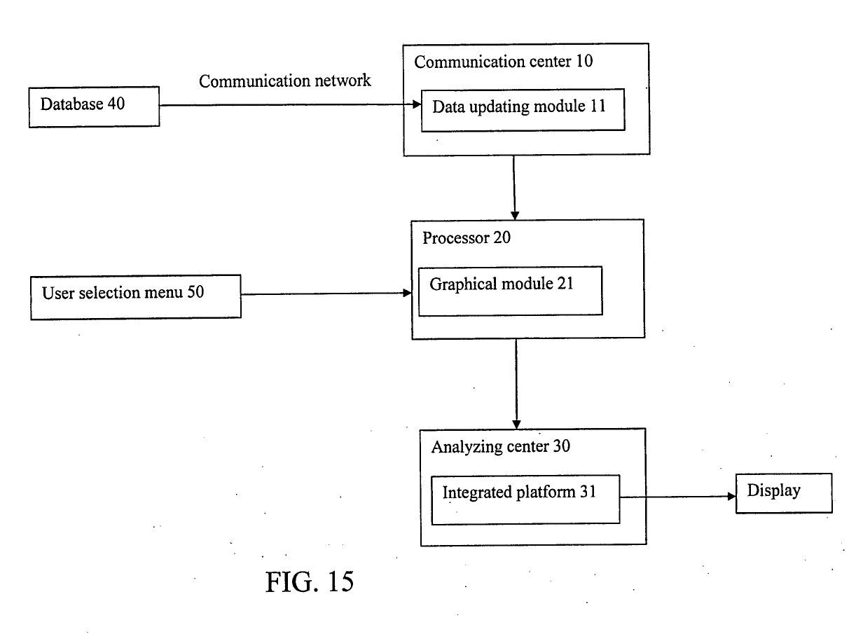

According to the preferred embodiment, the trend trading system comprises a communication center 10, a processor 20, an analyzing center 30, and a database 40, as shown in FIG. 15.

The communication center 10 collects the price data of the tradable object in a given period in a market, wherein the price data contains opening trade price, closing trade price, highest trade price, lowest trade price, trading volume, current trade price, etc.

The database 40 connects to the communication center 10 through a communication network, such as Internet, for collecting the price data of the tradable object. Accordingly, the communication center 10 comprises an automatic data updating module 11 that instantly updates the analyzed result in response to the price data in real-time. Therefore, as the price data passes from the database 40 to the communication center 10 in real time, the analyzed result is instantly updated by the data updating module 11 dynamically.

The processor 20 processes the price data to generate the trend stick chart, the power volume line, the 10 and 20 moving average line, and the price trend line. It is worth mentioning that the trend stick chart, having a plurality of trend sticks, indicates a market trend in response to the price data. The power volume line indicates a decisive trading position of the tradable object to make a trade at the current trade price in the market. The 10 and 20 moving average line shows a direction of the market trend at the decisive trading position. The price trend line confirms the decisive trading position and the changes of the market trend.

Accordingly, the processor 20 comprises a graphical module 21 that configures the price data in different graphical forms. The graphical module 21 configures each of trend sticks in the trend stick chart to have a body, an upper shadow and a lower shadow in response to the price. The graphical module 21 further arranges the trend sticks in a time sequence manner to indicate whether the market is on an upward or downward trend.

The analyzing center 30, which combines the trend stick chart, the power volume line, the 10 and 20 moving average line, and the price trend line to form a dynamically analyzed result for analyzing the tradable object in the market, integrates and displays trend stick chart, the power volume line, the 10 and 20 moving average line, and the price trend line in a single screen manner.

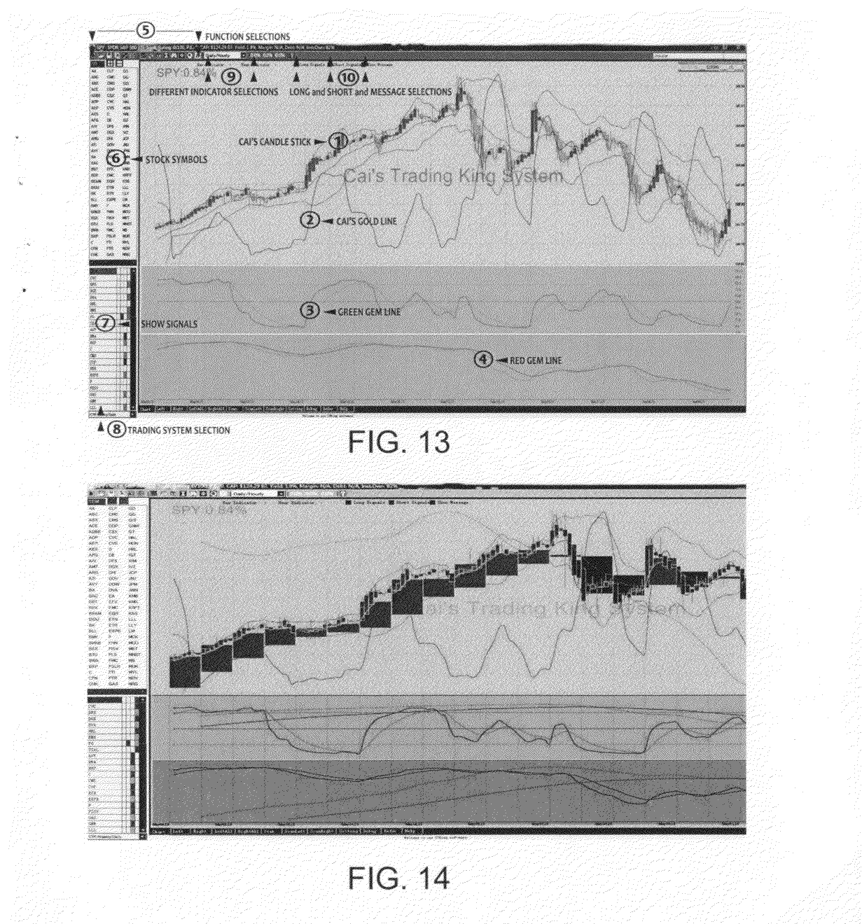

The analyzing center 30 encompasses an integrated platform 31, as shown in FIG. 12, in order to combine the trend stick chart, the power volume line, the 10 and 20 moving average line, and the price trend line in an integrated chart form with grid-lined guide. Therefore, traders are not required to switch different chart from screen to screen when comparing and analyzing the price data of the tradable object. For example, the trend stick chart can be shown only with the power volume line in a single display chart. It is worth mentioning that the graphical signal of the analyzed result can be sent to an output device, such as a computer screen, a mobile phone screen, tablet, or other electronic devices for display, or to a printer for a hard copy on paper.

In reference to the power volume line, the analyzing center 30 determines a volume difference ratio in response to the trading volumes of the tradable object in one single trade or multiple trades in order to form the power volume line for analyzing trading activities of “market-makers-like” in the market. The power volume line is compared with the 10 and 20 moving average line to spot a particular decisive trading position of the tradable object in order to make a trade at the current trade price in the market.

The analyzing center 30 also forms the “Over Buy” and “Over Sell” regions in the price trend chart and determines whether the current trade price will start changing at the price turning point or when the price trend line falls in the “Over Buy” or “Over Sell” region.

The trend trade system (the Cai's Trading System which further comprises a user selection menu 50 for traders to select different operations of the system, provides the user selection steps of: (i) establishing a profile for the tradable object to be executed and to be saved; (ii) providing at least a recommended tradable object to be analyzed; (iii) saving the trend stick chart, the power volume line, the 10 and 20 moving average line, and the price trend line; (iv) exporting the price data to a file in table format; (v) searching existing tradable objects in the market; (vi) selectively highlighting a portion of the trend stick chart, the power volume line, the 10 and 20 moving average line, and the price trend line for further viewing; (vii) selecting a time frame for the trend stick chart, the power volume line, the 10 and 20 moving average line, and the price trend line to be displayed; (viii) providing different trading schemes for the tradable object; and (ix) providing different indicators that indicate the price trend and market trend on the trend stick chart, the power volume line, the 10 and 20 moving average line, and the price trend line.

According to the present invention, the trend trading system can be packaged as a software or an “App” that can be installed on electronic devices. Traders can execute the trend trading system and select a desired tradable object, such that the trend trading system will then automatically collect the price data and generate an analysis in response to the particular selected tradable object. When selecting a second tradable object by the trader, the trend trading system will also automatically collect the price data and generate a new analysis in response to the second tradable object.

FIG. 13 illustrates the operational interface of the trend trading system which enables traders to select different tradable objects and select different operations through the user selection menu 50. FIG. 14 illustrates the displaying interface of the trend trading system which displays of the resulted analysis on the display on an electronic device.

The present invention further provides a trend trading method which comprises the following steps.

(1) Selects the tradable object.

(2) Collects price data of the tradable object in a given period in the market through the communication center 10.

(3) Generates the trend stick chart via the processor 20 by the following steps.

(3.1) Forms the body of each of the trend sticks in the trend stick chart in response to the opening trade and the closing trade prices.

(3.2) Forms an upper shadow and a lower shadow of each of the trend sticks in response to the highest trade and the lowest trade prices.

(3.3) Identifies the trend sticks in a time sequence manner to indicate whether there is an upward or downward trend in the market.

(4) Generates the power volume line via the processor 20 by the following steps.

(4.1) Determines the volume difference ratio in response to the trading volumes of the tradable object in one single trade and multiple trades in order to form the power volume line for analyzing trading activities of “market-makers-like” in the market.

(4.2) Compares the power volume line with the 10 and 20 moving average line to spot the decisive trading position of the tradable object to make a trade at the current trade price in the market.

(5) Provides the 10 and 20 moving average line.

(6) Generates the price trend line via the processor 20 by the following steps.

(6.1) Forms a price trend line which consists of a fast line and a slow line, showing the strength, direction, and momentum in price change and clearly indicates a price trend cycle.

(6.2) Defines “Cross Over” or “Death Fork” on the price trend line when there is a difference between the current trade price and the closing trade price and forms a price turning point, so as to show a change of the price trend and a turning point of the price trend by the following steps.

(6.2.1) Defines the “Cross Over” at the price trend line when the fast line is above and intersects with the slow line.

(6.2.2) Defines the “Death Fork” at the price trend line when the fast line is below and intersects with the slow line.

(6.3) Defines “Over Buy” and “Over Sell” regions in the price trend line.

(6.4) Determines whether the current trade price starts to change at the price turning point or when the price trend line falls in “Over Buy” or “Over Sell” region.

(7) Combines the trend stick chart, the power volume line, the 10 and 20 moving average line, and the price trend line to form a resulted analysis dynamically in real-time.

(8) Displays the resulted analysis for analyzing the tradable object in the market.

(9) Instantaneously updates the resulted analysis of any changes of the price data in real-time.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A trend trading method, comprising the steps of:
(a) collecting price data of a tradable object in a given period in a market, wherein the price data contains opening trade price, closing trade price, highest trade price, lowest trade price, trading volume, and current trade price;
(b) generating a plurality of trend sticks in a trend stick chart that indicates a market trend in response to the price data;
(c) generating a power volume line that indicates a decisive trading position of the tradable object to make a trade at the current trade price in the market;
(d) providing 10 and 20 moving average line that shows a direction of the market trend at the decisive trading position;
(e) generating a price trend line that confirms the decisive trading position and the direction of the market trend; and
(f) combining and displaying the trend stick chart that combines the power volume line, the 10 and 20 moving average line, and the price trend line to form a resulted analysis dynamically of the tradable object in the market.

2. The method, as recited in claim 1, wherein the step (b) further comprises the steps of:
(b.1) forming a body of each of the trend sticks in the trend stick chart in response to the opening and the closing trade prices;
(b.2) forming one of an upper shadow and a lower shadow of each of the trend sticks in response to the highest and the lowest trade prices, respectively;
(b.3) identifying the trend sticks in a time sequence manner to indicate the market trend whether there is an upward or downward trend on the market, wherein only the upper shadow is formed when there is an upward trend in the market and only the lower shadow is formed when there is a downward trend in the market.

3. The method, as recited in claim 2, wherein each of the trend sticks is represented with one of bullish color and bearish color to show whether there is an upward or downward one the market.

4. The method, as recited in claim 1, wherein the step (c) further comprises the steps of:
(c.1) determining a volume difference ratio in response to the trading volumes of the tradable object in one single trade and multiple trades in order to form the power volume line for analyzing trading activities of “market-maker-like” in the market; and
(c.2) comparing the power volume line with the 10 and 20 moving average line to spot the decisive trading position of the tradable object to make a trade at the current trade price in the market.

5. The method, as recited in claim 3, wherein the step (c) further comprises the steps of:
(c.1) determining a volume difference ratio in response to the trading volumes of the tradable object in one single trade and multiple trades in order to form the power volume line for analyzing trading activities of “market-maker-like” in the market; and
(c.2) comparing the power volume line with the 10 and 20 moving average line to spot the decisive trading position of the tradable object to make a trade at the current trade price in the market.

6. The method, as recited in claim 1, wherein the step (e) further comprises the steps of:
(e.1) configuring the price trend line that shows the strength, direction, and momentum in price change and clearly indicates a price trend cycle; and
(e.2) defining “Cross Over” or “Death Fork” on the price trend line when a difference between the current trade price and the closing trade price forms a price turning point, so as to show a change of the price trend and a turning point of the price trend.

7. The method, as recited in claim 5, wherein the step (e) further comprises the steps of:
(e.1) configuring the price trend line that shows the strength, direction, and momentum in price change and clearly indicates a price trend cycle; and
(e.2) defining “Cross Over” or “Death Fork” on the price trend line when a difference between the current trade price and the closing trade price forms a price turning point, so as to show a change of the price trend and a turning point of the price trend.

8. The method, as recited in claim 6, wherein the price trend line consists of a fast line that is determined based on KD line and a slow line that is determined based on MACD, wherein the step (e.2) further comprises the steps of:
(e.2.1) defining the “Cross Over” at the price trend line when the fast line is above and intersects with the slow line; and
(e.2.2) defining the “Death Fork” at the price trend line when the fast line is below and intersects with the slow line.

9. The method, as recited in claim 7, wherein the price trend line consists of a fast line that is determined based on KD line and a slow line that is determined based on MACD, wherein the step (e.2) further comprises the steps of:
(e.2.1) defining the “Cross Over” at the price trend line when the fast line is above and intersects with the slow line; and
(e.2.2) defining the “Death Fork” at the price trend line when the fast line is below and intersects with the slow line.

10. The method, as recited in claim 8, wherein the step (e) further comprises the steps of:
(e.3) defining an “Over Buy” and “Over Sell” regions in the price trend line; and
(e.4) determining whether the current trade price starts to change at the price turning point when the price trend line falls in the “Over Buy” or “Over Sell” region.

11. The method, as recited in claim 9, wherein the step (e) further comprises the steps of:
(e.3) defining an “Over Buy” and “Over Sell” regions in the price trend line; and
(e.4) determining whether the current trade price starts changing at the price turning point when the price trend line falls in the “Over Buy” or “Over Sell” region.

12. The method, as recited in claim 1, wherein the trend stick chart, the power volume line, the 10 and 20 moving average line, and the price trend line are displayed in a single screen.

13. The method, as recited in claim 11, wherein the trend stick chart, the power volume line, the 10 and 20 moving average line, and the price trend line are displayed in a single screen.

14. The method, as recited in claim 1, wherein the trend stick chart, the power volume line, the 10 and 20 moving average line, and the price trend line are generated by a processor.

15. The method, as recited in claim 13, wherein the trend stick chart, the power volume line, the 10 and 20 moving average line, and the price trend line are generated by a processor.

16. The method, as recited in claim 1, wherein the step (a) further comprises a step of connecting to a database through a communication network to collect the price data of the tradable object.

17. The method, as recited in claim 15, wherein the step (a) further comprises a step of connecting to a database through a communication network to collect the price data of the tradable object.

18. The method, as recited in claim 1, wherein the step (f) further comprises a step of instantaneously and dynamically updating the resulted analysis of any changes of the price data in real-time.

19. The method, as recited in claim 17, wherein the step (f) further comprises a step of instantaneously and dynamically updating the resulted analysis of any changes of the price data in real-time.

20. The method, as recited in claim 19, further comprising user selection steps of:
(i) establishing a profile for the tradable object to be executed and to be saved;
(ii) providing at least a recommended tradable object to be analyzed;
(iii) saving the display of the trend stick chart, the power volume line, the 10 and 20 moving average line, and the price trend line;
(iv) exporting the price data to a file in table format;
(v) searching existing tradable objects in the market;
(vi) selectively highlighting a portion of the trend stick chart, the power volume line, the 10 and 20 moving average line, and the price trend line to be further reviewed later;
(vii) selecting a time frame for the trend stick chart, the power volume line, the 10 and 20 moving average line, and the price trend line to be displayed;
(viii) providing different trading schemes for the tradable object; and
(ix) providing different indicators that indicate the price trend and market trend on the trend stick chart which consists of the power volume line, the 10 and 20 moving average line, and the price trend line.

21. A trend trading system, comprising:
a communication center for collecting price data of a tradable object in a given period in a market, wherein the price data contains opening trade price, closing trade price, highest trade price, lowest trade price, trading volume, and current trade price;
a processor processing the price data to generate a trend stick chart that includes a power volume line, 10 and 20 moving average line, a price trend line, wherein the trend stick chart has a plurality of trend sticks and indicates a market trend in response to the price data, wherein the power volume line indicates a decisive trading position of the tradable object to make a trade at the current trade price in the market, wherein the 10 and 20 moving average line shows a direction of the market trend at the decisive trading position, wherein the price trend line confirms the decisive trading position and the direction of the market trend; and
an analyzing center, which is arranged for analyzing the tradable object in the market, combining the trend stick chart, the power volume line, the 10 and 20 moving average line, and the price trend line to form a resulted analysis dynamically in real time, wherein the trend stick chart, the power volume line, the 10 and 20 moving average line, and the price trend line are integrated and displayed in a single screen manner.

22. The trend trading system, as recited in claim 21, wherein the processor comprises a graphical module that configures each of the trend sticks in the trend stick chart to have a body according to the opening and the closing trade price, an upper shadow and a lower shadow in response to the highest and lowest trade prices respectively, wherein the graphical module further arranging the trend sticks in a time sequence manner to indicate the market trend whether there is an upward or a downward trend in the market, wherein only the upper shadow is formed when there is an upward trend in the market and only the lower shadow is formed when there is a downward trend in the market.

23. The trend trading system, as recited in claim 22, wherein each of the trend sticks is represented with bullish (green) color or bearish (red) color to show whether there is an upward or downward trend in the market.

24. The trend trading system, as recited in claim 21, wherein said analyzing center determines a volume difference ratio in response to the trading volumes of the tradable object in one single trade and multiple trades in order to form the power volume line for analyzing trading activities of “market-maker-like” in the market, and compares the power volume line with the 10 and 20 moving average line to spot a decisive trading position of the tradable object to make a trade at the current trade price in the market.

25. The trend trading system, as recited in claim 21, wherein said analyzing center forms a price trend line on the price trend that shows the strength, direction, and momentum in price change and clearly indicates a price trend cycle, and also defines “Cross Over” or “Death Fork” on the price trend line when a difference between the current trade price and the closing trade price forms a price turning point, so as to show a change of the price trend and a turning point of the price trend.

26. The trend trading system, as recited in claim 25, wherein the price trend line consists of a fast line determined based on KD line and a slow line determined based on MACD, wherein the “Cross Over” is defined at the price trend line when the fast line is above and intersects with the slow line, wherein the “Death Fork” is defined at the price trend line when the fast line is below and intersects with the slow line.

27. The trend trading system, as recited in claim 26, wherein the analyzing center forms “Over Buy” and “Over Sell” regions in the price trend line, and determines whether the current trade price starts changing at the price turning point when the price trend line falls in the “Over Buy” or “Over Sell” region.

28. The trend trading system, as recited in claim 21, wherein the analyzing center provides an integrated platform to combine the trend stick chart, the power volume line, the 10 and 20 moving average line, and the price trend line in an integrated chart form.

29. The trend trading system, as recited in claim 21, further comprising a database that connects to the communication center through a communication network for collecting the price data of the tradable object.

30. The trend trading system, as recited in claim 21, wherein the communication center further comprises an automatic data updating module that instantaneously and dynamically updates the resulted analysis of any changes of the price data in real time.
